(19) United States
(12) Patent Application Publication
(10) Pub. No.: US 2021/0177694 A1
(43) Pub. Date: Jun. 17, 2021

(54) SAUNA APPARATUS

(71) Applicant: Mitchell Ryan Arnold, Lake Saint Louis, MO (US)

(72) Inventor: Mitchell Ryan Arnold, Lake Saint Louis, MO (US)

(21) Appl. No.: 16/710,394

(22) Filed: Dec. 11, 2019

(51) Int. Cl. A61H 33/06

(52) U.S. Cl. CPC A61H 33/067; A61H 33/065; A61H 2033/068; A61H 2033/061; A61H 2201/0242; A61H 2201/1207; A61H 2201/1633; A61H 2201/0221

(57) ABSTRACT

This invention relates to a sauna with reduced dimensions such that the size, assembly time, material costs, and operating costs (e.g., power, heat, etc.) are reduced while still offering the end-user an enjoyable sauna experience. More particularly, various embodiments of the present invention relate to a sauna having a bottom surface, a top surface parallel to the bottom surface, and a front surface connecting the bottom surface to the top surface, wherein the front surface and bottom surface typically form an angle less than about 90°.

### BACKGROUND

Traditional rigid-frame saunas are buildings, or rooms in buildings, designed as a place to experience dry or wet heat sessions. For example, common Finnish-style saunas, from which many sauna designs originate, are typically permanent stand-alone buildings separate from the main house, designed to sit multiple individuals and requiring significant pre-heating times and large amounts of energy. Traditional large or permanent structures are impractical for many consumers due to their size, difficulty and expense of construction, cost and effort of maintenance, and large energy requirements. More recent sauna designs attempt to deliver the traditional sauna experience with semi-permanent saunas that are shipped to and assembled on site, often by the end-user. However, the current offering of rigid-frame saunas are still large and inefficient for many end-users. Users often experience difficulty fitting such saunas into homes, apartments, locker rooms, places of business, etc. Most currently available designs require significant installation efforts, often taking several hours, and can weigh several hundred pounds. Alternative designs, including non-rigid-frame designs, are available, but often at the cost of the end-user's comfort and the sauna experience and aesthetic.

Thus, a need exists for a sauna having reduced size and weight, expense of construction, assembly time, and overall energy demand.

### SUMMARY

Briefly, therefore, the present invention is directed to a sauna with reduced dimensions such that the size, assembly time, material costs, and operating costs (e.g., power, heat, etc.) are reduced while still offering the end-user an enjoyable sauna experience.

In one embodiment, a sauna includes a bottom surface, a top surface parallel to the bottom surface, and a front surface connecting the bottom surface and/or optional bottom heel surface to the top surface and/or optional top heel surface. The front surface and bottom surface typically form an angle less than 90°. A plurality of additional surfaces are in contact with at least one of the bottom surface, top surface, and front surface such that the surfaces form an interior volume defined by the surfaces. At least one of the front surface and the one or more additional surfaces includes a door. The sauna includes one or more heating components. In one embodiment, the interior volume includes a seat including a horizontal surface.

In another embodiment, a sauna includes a bottom surface, an optional bottom heel surface connected to the bottom surface and extending upwardly therefrom, a top surface parallel to the bottom surface, an optional top heel surface connected to the top surface and extending downwardly therefrom, and a front surface connecting the bottom surface and/or optional bottom heel surface to the top surface and/or optional top heel surface. The front surface and bottom surface typically form an angle less than 90°. A plurality of additional surfaces are in contact with at least one of the bottom surface, optional bottom heel surface, top surface, optional top heel surface, and front surface such that the surfaces form an interior volume defined by the surfaces. At least one of the front surface and the one or more additional surfaces includes a door. The sauna includes one or more heating components. In one embodiment, the interior volume includes a seat including a horizontal surface.

In another embodiment, a sauna includes a bottom surface, an optional bottom heel surface connected to the bottom surface and extending upwardly therefrom, a top surface parallel to the bottom surface, an optional top heel surface connected to the top surface and extending downwardly therefrom, and a front surface including a door and connecting the bottom surface and/or optional bottom heel surface to the top surface and/or optional top heel surface. The front surface and bottom surface typically form an angle less than 90°. A plurality of additional surfaces are in contact with at least one of the bottom surface, optional bottom heel surface, top surface, optional top heel surface, and front surface such that the surfaces form an interior volume defined by the surfaces. The sauna includes one or more heating components. In one embodiment, the interior volume includes a seat including a horizontal surface.

The dimensions of the sauna are such that the sauna has a reduced volume compared to that of a traditional rectangular-prism shaped sauna. This is accomplished, in part, from ensuring that the angle between the front surface and the bottom surface is less than 90°. This reduced volume offers advantageous properties regarding cost, size, and operation. Surprisingly, these advantages are obtained without compromising the end-user's comfort and sauna experience.

In another embodiment, a kit for assembling a sauna is provided and includes a bottom surface, a top surface, a front surface, a plurality of additional surfaces, one or more heating components, and a seat. At least one of the front surface and the one or more additional surfaces includes a door. The top surface is configured to be parallel to the bottom surface when the sauna is assembled. The front surface is configured to be situated above the bottom surface and below the top surface, and the front surface and bottom surface are configured to form an angle less than 90° when the sauna is assembled. The plurality of additional surfaces are configured to be connected to the bottom surface, top surface, and/or front surface such that the surfaces form an interior volume defined by the surfaces, and the seat is configured to be situated in the interior volume.

In another embodiment, a kit for assembling a sauna is provided and includes a bottom surface, an optional bottom heel surface, a top surface, an optional top heel surface, a front surface, a plurality of additional surfaces, one or more heating components, and a seat. At least one of the front surface and the one or more additional surfaces includes a door. The top surface is configured to be parallel to the bottom surface when the sauna is assembled. The optional bottom heel surface is configured to be connected to the bottom surface and extend upwardly therefrom and the optional top heel surface is configured to be connected to the top surface and extend downwardly therefrom. The front surface is configured to be situated above the bottom surface and/or optional bottom heel surface and below the top surface and/or optional top heel surface, and the front surface and bottom surface are configured to form an angle less than 90° when the sauna is assembled. The plurality of additional surfaces are configured to be connected to the bottom surface, optional bottom heel surface, top surface, optional top heel surface, and/or front surface such that the surfaces form an interior volume defined by the surfaces, and the seat is configured to be situated in the interior volume.

In another embodiment, a kit for assembling a sauna is provided and includes a bottom surface, an optional bottom heel surface, a top surface, an optional top heel surface, a front surface, a plurality of additional surfaces, one or more heating components, and a seat. The front surface includes a door. The top surface is configured to be parallel to the bottom surface when the sauna is assembled. The optional bottom heel surface is configured to be connected to the bottom surface and extend upwardly therefrom and the optional top heel surface is configured to be connected to the top surface and extend downwardly therefrom. The front surface is configured to be situated above the bottom surface and/or optional bottom heel surface and below the top surface and/or optional top heel surface, and the front surface and bottom surface are configured to form an angle less than 90° when the sauna is assembled. The plurality of additional surfaces are configured to be connected to the bottom surface, optional bottom heel surface, top surface, optional top heel surface, and/or front surface such that the surfaces form an interior volume defined by the surfaces, and the seat is configured to be situated in the interior volume.

### BRIEF DESCRIPTION OF THE FIGURES

FIG. 1 illustrates a sauna with the front surface shown as see-through to make the interior volume visible.

FIG. 2 shows the sauna of FIG. 1 from a front view.

FIG. 3 shows the sauna of FIG. 1 from a profile view.

FIG. 4 demonstrates the angles and configuration of the sauna of FIG. 1.

FIG. 5 illustrates a further sauna with the front surface shown as see-through to make the interior volume visible.

FIG. 6 illustrates the sauna of FIG. 5 with the door open.

### DETAILED DESCRIPTION

The subject matter described herein generally relates to saunas having a reduced size. Particularly, rigid-frame saunas with dimensions such that size, assembly time, material costs, energy costs, etc. are reduced while still offering the end-user an enjoyable sauna experience.

In one embodiment, the sauna of the present invention includes a bottom surface, a top surface parallel to the bottom surface, and a front surface connecting the bottom surface and/or optional bottom heel surface to the top surface and/or optional top heel surface. At least one of the front surface and the plurality of additional surfaces includes a door. The front surface and bottom surface or front surface and optional bottom heel surface typically form an angle less than 90°. For example, less than about 85°, less than about 80°, or less than about 75°. In certain embodiments, the front surface and bottom surface or front surface and optional bottom heel surface form an angle less than about 73.8°. In certain embodiments, the front surface and bottom surface or front surface and optional bottom heel surface form an angle from about 65° to about 90°, from about 65° to about 80°, from about 65° to about 75°, from about 65° to about 70°, from about 70° to about 90°, from about 70° to about 80°, from about 70° to about 75°, from about 75° to about 90°, or from about 75° to about 80°. In certain embodiments, the front surface and bottom surface or front surface and optional bottom heel surface form an angle from about 65° to about 73.8°, from about 70° to about 73.8°, from about 73.8° to about 90°, from about 73.8° to about 80°, or from about 73.8° to about 75°.

In one embodiment, the sauna of the present invention includes a bottom surface, an optional bottom heel surface connected to the bottom surface and extending upwardly therefrom, a top surface parallel to the bottom surface, an optional top heel surface connected to the top surface and extending downwardly therefrom, and a front surface connecting the bottom surface and/or optional bottom heel surface to the top surface and/or optional top heel surface. At least one of the front surface and the plurality of additional surfaces includes a door. The front surface and bottom surface or front surface and optional bottom heel surface typically form an angle less than 90°. For example, less than about 85°, less than about 80°, or less than about 75°. In certain embodiments, the front surface and bottom surface or front surface and optional bottom heel surface form an angle less than about 73.8°. In certain embodiments, the front surface and bottom surface or front surface and optional bottom heel surface form an angle from about 65° to about 90°, from about 65° to about 80°, from about 65° to about 75°, from about 65° to about 70°, from about 70° to about 90°, from about 70° to about 80°, from about 70° to about 75°, from about 75° to about 90°, or from about 75° to about 80°. In certain embodiments, the front surface and bottom surface or front surface and optional bottom heel surface form an angle from about 65° to about 73.8°, from about 70° to about 73.8°, from about 73.8° to about 90°, from about 73.8° to about 80°, or from about 73.8° to about 75°.

In another embodiment, the front surface includes a door.

In one embodiment, the sauna of the present invention includes a bottom surface, an optional bottom heel surface connected to the bottom surface and extending upwardly therefrom, a top surface parallel to the bottom surface, an optional top heel surface connected to the top surface and extending downwardly therefrom, and a front surface connecting the bottom surface and/or optional bottom heel surface to the top surface and/or optional top heel surface. The front surface includes a door. The front surface and bottom surface or front surface and optional bottom heel surface typically form an angle less than 90°. For example, less than about 85°, less than about 80°, or less than about 75°. In certain embodiments, the front surface and bottom surface or front surface and optional bottom heel surface form an angle less than about 73.8°. In certain embodiments, the front surface and bottom surface or front surface and optional bottom heel surface form an angle from about 65° to about 90°, from about 65° to about 80°, from about 65° to about 75°, from about 65° to about 70°, from about 70° to about 90°, from about 70° to about 80°, from about 70° to about 75°, from about 75° to about 90°, or from about 75° to about 80°. In certain embodiments, the front surface and bottom surface or front surface and optional bottom heel surface form an angle from about 65° to about 73.8°, from about 70° to about 73.8°, from about 73.8° to about 90°, from about 73.8° to about 80°, or from about 73.8° to about 75°.

In another embodiment, the bottom surface is defined by a bottom length and a bottom width and the top surface is defined by a top length and a top width, and the ratio of the bottom length to the top length is from about 5:1 to about 1:1, from about 4:1 to about 1:1, from about 3:1 to about 1:1, from about 2:1 to about 1:1, from about 1.9:1 to about 1:1, from about 1.8:1 to about 1:1, from about 1.7:1 to about 1:1, from about 1.6:1 to about 1:1, from about 1.5:1 to about 1:1, from about 1.4:1 to about 1:1, from about 1.3:1 to about 1:1, from about 1.2:1 to about 1:1, or from about 1.1:1 to about 1:1.

In another embodiment, the bottom surface is defined by a bottom surface area defined by a bottom length and a bottom width and the top surface is defined by a top surface area defined by a top length and a top width, and the ratio of the bottom surface area to the top surface area is from about 5:1 to about 1:1, from about 4:1 to about 1:1, from about 3:1 to about 1:1, from about 2:1 to about 1:1, from about 1.9:1 to about 1:1, from about 1.8:1 to about 1:1, from about 1.7:1 to about 1:1, from about 1.6:1 to about 1:1, from about 1.5:1 to about 1:1, from about 1.4:1 to about 1:1, from about 1.3:1 to about 1:1, from about 1.2:1 to about 1:1, or from about 1.1:1 to about 1:1.

In one embodiment, the bottom surface is defined by a bottom length and a bottom width and the bottom length is from about 20 in. to about 60 in., from about 25 in. to about 60 in., or from about 30 in. to about 60 in. and the top length is from about 20 in. to about 55 in., from about 20 in. to about 50 in., or from about 20 in. to about 45 in. In certain embodiments, the bottom width is from about 20 in. to about 60 in., from about 25 in. to about 60 in., from about 25 in. to about 55 in., from about 25 in. to about 50 in., from about 30 in. to about 45 in., from about 30 in. to about 40 in., or from about 30 in. to about 35 in.

In another embodiment, the distance between the top surface and the bottom surface defines a height of the sauna. In certain embodiments, the height of the sauna is about 8 ft. or less, about 7.75 ft. or less, about 7.5 ft. or less, about 7.25 ft. or less, about 7 ft. or less, about 6.75 ft. or less, about 6.5 ft. or less, about 6.25 ft. or less, about 6 ft. or less, about 5.75 ft. or less, about 5.5 ft. or less, about 5.25 ft. or less, about 5 ft. or less, about 4.75 ft. or less, or about 4.5 ft. or less.

In one embodiment, the door includes tempered glass, insulated tempered glass, thermopane glass, annealed glass, or plastic, of from about 0.2 in. to about 1.0 in. thickness.

In certain embodiments, the door is treated or coated to retain at least about 10%, at least about 20%, at least about 30%, at least about 50%, at least about 60% at least about 70%, at least about 80%, at least about 90%, at least about 99%, or at least about 99.9% of incident electromagnet radiation with a wavelength of from about 0.7 μm to about 1 mm, from about 0.7 μm to about 100 μm, from about 0.7 μm to about 10 μm, from about 0.7 μm to about 5 μm, from about 0.7 μm to about 3 μm, from about 1.5 μm to about 1 mm, from about 1.5 μm to about 100 μm, from about 1.5 μm to about 10 μm, from about 1.5 μm to about 5 μm, from about 1.5 μm to about 3 μm, from about 2 μm to about 10 μm, from about 2 μm to about 5 μm, from about 2 μm to about 3 μm, from about 3 μm to about 1 mm, from about 3 μm to about 100 μm, from about 3 μm to about 10 μm, from about 3 μm to about 5 μm, from about 5 μm to about 1 mm, from about 5 μm to about 100 μm, or from about 5 μm to about 10 μm. For example, in one embodiment, the door is treated or coated to retain at least 10%, at least 20%, at least 30%, at least 50%, at least 60% at least 70%, at least 80%, at least 90% or at least 99% of incident electromagnet radiation with a wavelength higher than about 0.7 μm, 1.5 μm, 2 μm, 3 μm, 5 μm, or 10 μm.

In one embodiment, the door may be treated or coated.

In one embodiment, the bottom surface, top surface, front surface, optional top or bottom heel, and/or plurality of additional surfaces may be made of any material known to a person of skill in the art. These materials may include, for example, wood, plastic, vinyl, steel, brass, silicone, and combinations thereof. In embodiments wherein one or more of the surfaces comprises wood, the wood may be selected from the group consisting of cedar, basswood, eucalyptus, hemlock, spruce, pine, and combinations thereof. In one embodiment, at least one of the bottom, top, front, optional top or bottom heel, or plurality of additional surfaces consists essentially of wood.

In certain embodiments, the sauna comprises one or more heating components. In one embodiment, the one or more heating components includes an electric heating element, heated stones, fire, steam, metal wire, gas heater, or fan heater.

In another embodiment, the one or more heating components includes one or more infrared heaters. In certain embodiments, the one or more infrared heaters are selected from the group consisting of a carbon infrared heater, carbon fiber infrared heater, infrared ceramic plates, far infrared heater made of one or more of nickel, ferroalloy, Fecralloy®, quartz, tungsten, iron-chromium-aluminum alloy, and gold, and combinations thereof.

Fecralloy® is an alloy which includes iron, chromium, aluminum, and yttrium.

In another embodiment, the interior volume further includes at least one of a temperature sensor, temperature control dial, temperature timer, clock, multi-colored light, or speaker.

In another embodiment, at least one of the bottom, top, front, or plurality of additional surfaces comprises a window, vent, opening, door handle, or towel rack.

In one embodiment, the interior volume is no greater than about 80,000 in.³, no greater than about 75,000 in.³, no greater than about 70,000 in.³, no greater than about 65,000 in.³, no greater than about 60,000 in.³, no greater than about 55,000 in.³, no greater than about 50,000 in.³, no greater than about 45,000 in.³, or no greater than about 40,000 in.³ In another embodiment, the interior volume is between about 40,000 in.³ and about 80,000 in.³, between about 40,000 in.³ and about 75,000 in.³, between about 40,000 in.³ and about 70,000 in.³, between about 45,000 in.³ and about 65,000 in.³, or between about 45,000 in.³ and about 50,000 in.³

In one embodiment, the heating component is capable of heating the interior volume to a temperature between about room temperature and about 230° F., between about room temperature and about 180° F., between about room temperature and about 150° F., between about room temperature and about 130° F., between about room temperature and about 115° F., or between about room temperature and about 100° F. Room temperature may be about 60° F. to about 80° F. In certain embodiments, room temperature is 70° F.

In one embodiment, the sauna is powered by a 120 volt outlet or a 240 volt outlet. For example, in one embodiment, the sauna is powered by a 120 volt wall-mounted outlet.

In another embodiment, a kit for assembling a sauna includes a bottom surface, a top surface, a front surface, a plurality of additional surfaces, one or more heating components, and a seat. At least one of the front surface and the one or more additional surfaces includes a door. The top surface is configured to be parallel to the bottom surface when the sauna is assembled. The front surface is configured to be situated above the bottom surface and below the top surface, and the front surface and bottom surface are configured to form an angle less than 90°, less than about 85°, less than about 80°, less than about 75°, or of about 73.8° when the sauna is assembled. In another embodiment, the angle is from about 65° to about 90°, from about 65° to about 80°, from about 65° to about 75°, from about 65° to about 70°, from about 70° to about 90°, from about 70° to about 80°, from about 70° to about 75°, from about 75° to about 90°, or from about 75° to about 80° when the sauna is assembled. In another embodiment, the angle is from about 65° to about 73.8°, from about 70° to about 73.8°, from about 73.8° to about 90°, from about 73.8° to about 80°, or from about 73.8° to about 75° when the sauna is assembled. The plurality of additional surfaces are configured to be connected to the bottom surface, top surface, and/or front surface such that the surfaces form an interior volume defined by the surfaces, and the seat is configured to be situated in the interior volume.

In another embodiment, a kit for assembling a sauna includes a bottom surface, an optional bottom heel surface, a top surface, an optional top heel surface, a front surface, a plurality of additional surfaces, one or more heating components, and a seat. At least one of the front surface and the one or more additional surfaces includes a door. The top surface is configured to be parallel to the bottom surface when the sauna is assembled. The optional bottom heel surface is configured to be connected to the bottom surface and extend upwardly therefrom and the optional top heel surface is configured to be connected to the top surface and extend downwardly therefrom. The front surface is configured to be situated above the bottom surface and/or optional bottom heel surface and below the top surface and/or optional top heel surface, and the front surface and bottom surface or front surface and optional bottom heel surface are configured to form an angle less than 90°, less than about 85°, less than about 80°, less than about 75°, or of about 73.8° when the sauna is assembled. In another embodiment, the angle is from about 65° to about 90°, from about 65° to about 80°, from about 65° to about 75°, from about 65° to about 70°, from about 70° to about 90°, from about 70° to about 80°, from about 70° to about 75°, from about 75° to about 90°, or from about 75° to about 80° when the sauna is assembled. In another embodiment, the angle is from about 65° to about 73.8°, from about 70° to about 73.8°, from about 73.8° to about 90°, from about 73.8° to about 80°, or from about 73.8° to about 75° when the sauna is assembled. The plurality of additional surfaces are configured to be connected to the bottom surface, optional bottom heel surface, top surface, optional top heel surface, and/or front surface such that the surfaces form an interior volume defined by the surfaces, and the seat is configured to be situated in the interior volume.

In another embodiment, a kit for assembling a sauna includes a bottom surface, an optional bottom heel surface, a top surface, an optional top heel surface, a front surface, a plurality of additional surfaces, one or more heating components, and a seat. The front surface includes a door. The top surface is configured to be parallel to the bottom surface when the sauna is assembled. The optional bottom heel surface is configured to be connected to the bottom surface and extend upwardly therefrom and the optional top heel surface is configured to be connected to the top surface and extend downwardly therefrom. The front surface is configured to be situated above the bottom surface and/or optional bottom heel surface and below the top surface and/or optional top heel surface, and the front surface and bottom surface or front surface and optional bottom heel surface are configured to form an angle less than 90°, less than about 85°, less than about 80°, less than about 75°, or of about 73.8° when the sauna is assembled. In another embodiment, the angle is from about 65° to about 90°, from about 65° to about 80°, from about 65° to about 75°, from about 65° to about 70°, from about 70° to about 90°, from about 70° to about 80°, from about 70° to about 75°, from about 75° to about 90°, or from about 75° to about 80° when the sauna is assembled. In another embodiment, the angle is from about 65° to about 73.8°, from about 70° to about 73.8°, from about 73.8° to about 90°, from about 73.8° to about 80°, or from about 73.8° to about 75° when the sauna is assembled. The plurality of additional surfaces are configured to be connected to the bottom surface, optional bottom heel surface, top surface, optional top heel surface, and/or front surface such that the surfaces form an interior volume defined by the surfaces, and the seat is configured to be situated in the interior volume.

The angle of the front surface and the bottom surface is such that the volume at about the top surface of the sauna is less than that at about the bottom surface of the sauna. Advantages of this include the ability of the sauna to be used in smaller rooms where other saunas are too large to fit. The angle of the front surface and the bottom surface also results in the sauna protruding less into the living space as compared to a traditional sauna. Additionally, the sauna has a lighter frame, enabling easier shipping and transportation. The sauna also uses fewer materials, reducing costs and assembly times.

Advantages of the sauna include the reduced interior volume compared to conventional rectangular-prism shaped saunas. For an example sauna of dimensions of about 60 in. tall, 32 in. wide, 40 in. deep at the bottom surface, 24 in. deep at the top surface, with a 5 in. vertical wooden heel at the bottom, the interior volume is about 18% less than that of a comparable sized rectangular-prism shaped sauna of the same dimensions but 40 in. deep at the top surface. The reduced interior volume offers advantageous properties including faster interior heating times and reduced energy expenditures for heating.

One advantage of the sauna is the ability of the inside of the sauna to reach a temperature of about 150° F. from about room temperature in as little as about 15 minutes.

One advantage of the sauna is the ability of the inside of the sauna to reach a temperature of about 150° F. from about room temperature in as little as 1500 watts.

One advantage of the sauna is its lighter weight. An example sauna has a weight of less than 250 pounds, while comparable prior saunas weigh in excess of 300.

In one embodiment, the sauna is configured such that the end-user when seated on the seat faces the front surface.

One advantage of the sauna is that the reduction in size and volume are obtained without compromising the comfort of the end-user. Because the sauna at about the lower portion affords more space than the sauna at about the upper portion, there is sufficient space for a seat and the end-user's legs without the end-user feeling as if their legs are confined. The sauna at about the upper portion, with its relatively smaller volume, is still sufficient to accommodate the end-user's head and shoulders without the user feeling constrained. The end-user experience may be further enhanced by having the front surface include a transparent material, or by having the front surface include a door including a transparent material.

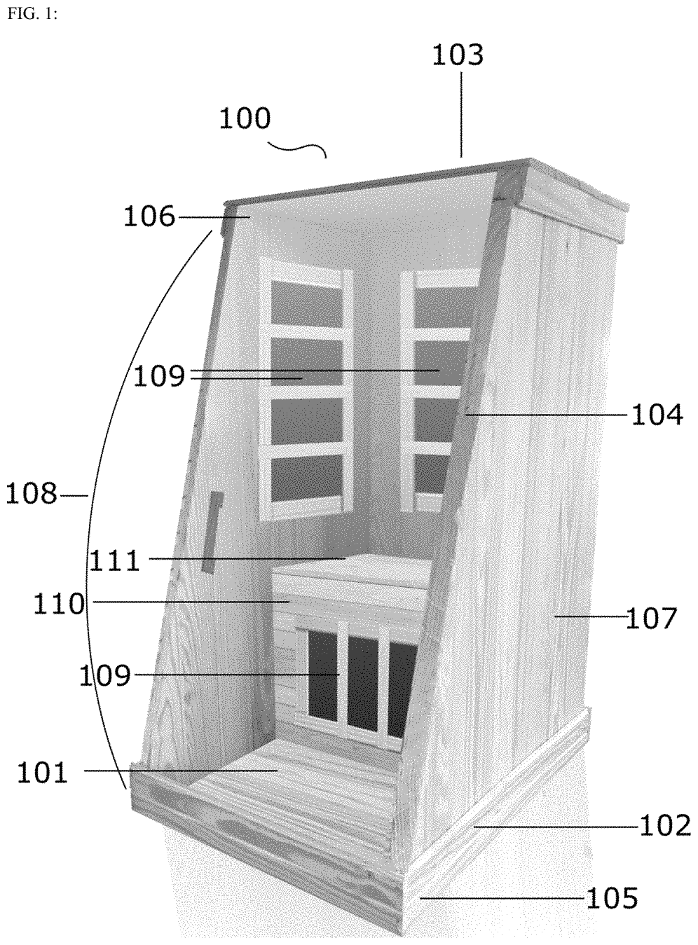

An example sauna 100 is shown in FIG. 1. The sauna 100 includes a bottom surface 101. FIG. 1 also shows a bottom heel surface 102 extending about the perimeter of the bottom surface 101, connected to the bottom surface 101, and extending upwardly therefrom. A top surface 103 is shown opposite the bottom surface 101. A front surface 104 is shown connecting the bottom heel surface 102 and top surface 103. The front surface 104 and bottom surface 101 are shown as forming an angle 105, where the angle 105 is measured from the intersection of the plane of the front surface 104 with the plane of the bottom surface 101. The front surface 104 includes a door 106. The door 106 is shown as being made of a transparent material, e.g. safety glass. The sauna 100 includes additional surfaces 107 in contact with at least one of the bottom heel surface 102, front surface 104, and top surface 103. The other additional surfaces 107 are arranged such that the surfaces form an interior volume 108, defined by the surfaces. The sauna 100 includes a plurality of heating components 109. The interior volume 108 includes a seat 110 including a horizontal surface 111.

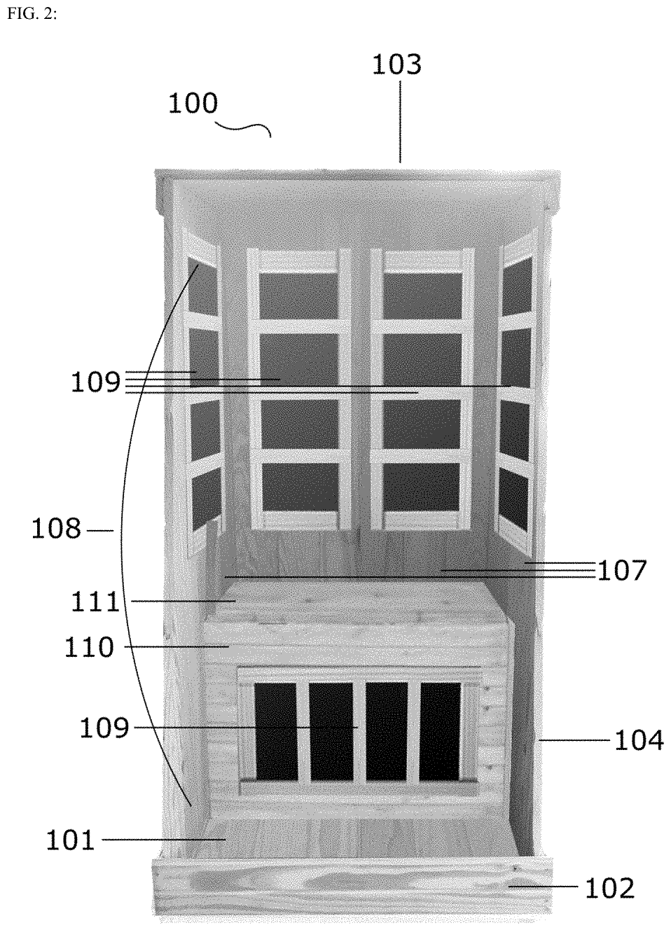

FIG. 2 shows a front view of the sauna 100 of FIG. 1. In this view, the plurality of heating components 109, the interior volume 108, and the seat 110 including the horizontal surface 111 are better shown.

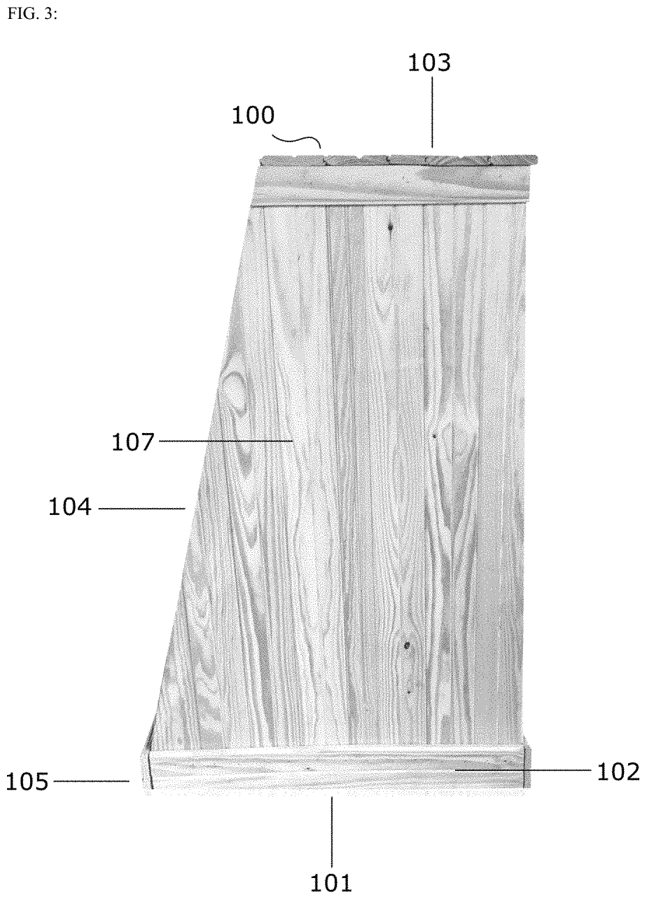

FIG. 3 shows a side view of the sauna of FIG. 1. In this view, the angle 105 formed by the front surface 104 and bottom surface 101 is better shown.

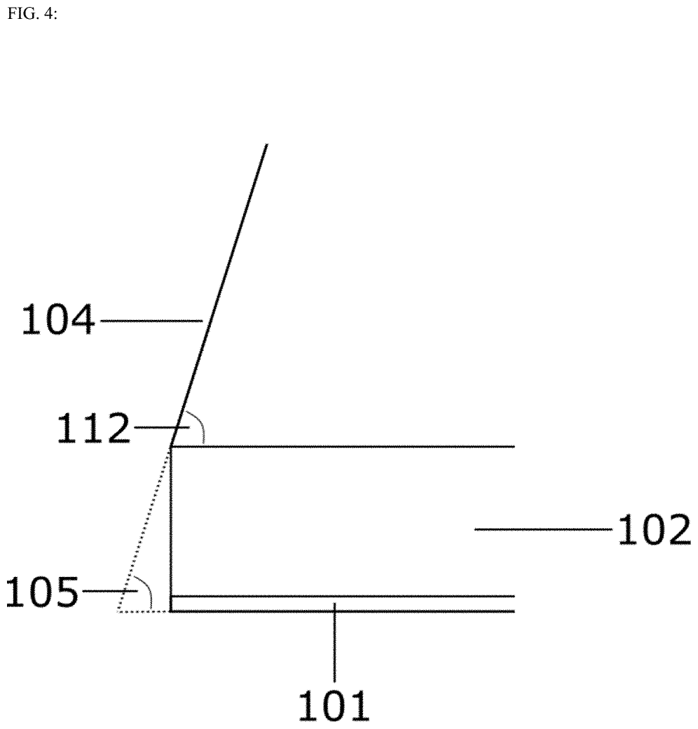

FIG. 4 shows a close-up view of the angle 105 formed by the front surface 104 and bottom surface 101 of the sauna of FIG. 1. The angle 105 is measured from the intersection of the plane of the front surface 104 with the plane of the bottom surface 101. The front surface also forms a heel angle 112 with the optional bottom heel surface, which may or may not have the same value as the angle 105 depending upon whether the sauna 100 includes the optional bottom heel surface 102 and the orientation of the optional bottom heel surface 102.

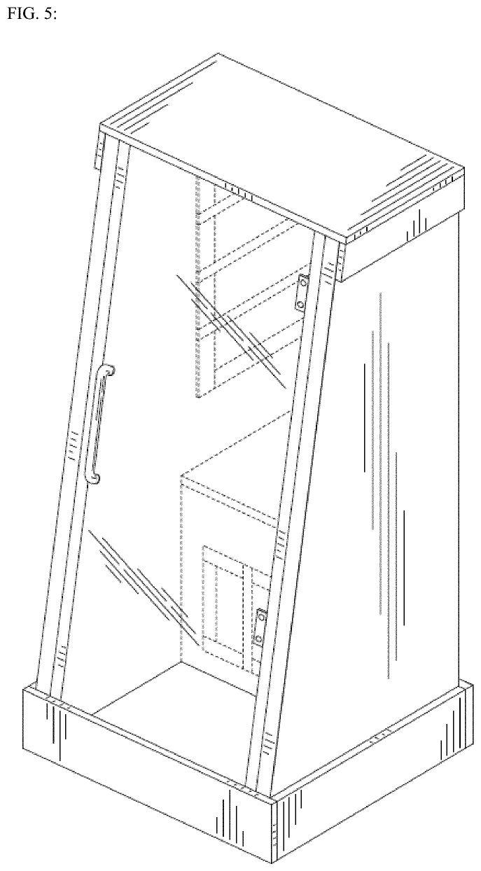

FIG. 5 shows another example sauna in accordance with the scope of the invention.

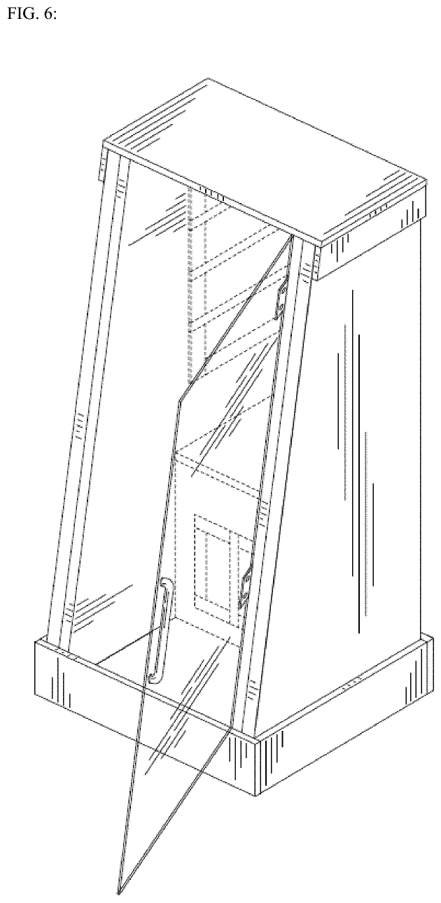

FIG. 6 shows the example sauna of FIG. 5 with the door open.

The preceding description and figures are not intended to limit the scope of the invention. The claimed subject matter might also be embodied in other ways, to include different combinations of elements and variations as would be envisioned by one of skill in the art.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above apparatus and methods without departing from the scope of the invention, it is intended that all matter contained in the above description and the associated drawings shall be interpreted as illustrative and not in a limiting sense.

1. A sauna, comprising:
a bottom surface;
an optional bottom heel surface connected to the bottom surface and extending upwardly therefrom;
a top surface parallel to the bottom surface;
an optional top heel surface connected to the top surface and extending downwardly therefrom;
a front surface connecting the bottom surface and/or optional bottom heel surface to the top surface and/or optional top heel surface, wherein the front surface and bottom surface form an angle less than 90°;
a plurality of additional surfaces in contact with at least one of the bottom surface, optional bottom heel surface, top surface, optional top heel surface, and front surface such that the surfaces form an interior volume defined by the surfaces; and
one or more heating components;
wherein the interior volume comprises a seat comprising a horizontal surface and at least one of the front surface and plurality of additional surfaces comprises a door.

2. The sauna of claim 1, wherein the front surface comprises a door.

3. The sauna of claim 1, wherein the bottom surface is defined by a bottom length and a bottom width and the top surface is defined by a top length and a top width, and the ratio of the bottom length to the top length is from about 5:1 to about 1:1, from about 4:1 to about 1:1, from about 3:1 to about 1:1, from about 2:1 to about 1:1, from about 1.9:1 to about 1:1, from about 1.8:1 to about 1:1, from about 1.7:1 to about 1:1, from about 1.6:1 to about 1:1, from about 1.5:1 to about 1:1, from about 1.4:1 to about 1:1, from about 1.3:1 to about 1:1, from about 1.2:1 to about 1:1, or from about 1.1:1 to about 1:1.

4. The sauna of claim 1, wherein the bottom surface is defined by a bottom surface area defined by a bottom length and a bottom width and the top surface is defined by a top surface area defined by a top length and a top width, and the ratio of the bottom surface area to the top surface area is from about 5:1 to about 1:1, from about 4:1 to about 1:1, from about 3:1 to about 1:1, from about 2:1 to about 1:1, from about 1.9:1 to about 1:1, from about 1.8:1 to about 1:1, from about 1.7:1 to about 1:1, from about 1.6:1 to about 1:1, from about 1.5:1 to about 1:1, from about 1.4:1 to about 1:1, from about 1.3:1 to about 1:1, from about 1.2:1 to about 1:1, or from about 1.1:1 to about 1:1.

5. The sauna of claim 1 wherein the bottom surface is defined by a bottom length and a bottom width and the bottom length is from about 20 in. to about 60 in., from about 25 in. to about 60 in., or from about 30 in. to about 60 in. and the top length is from about 20 in. to about 55 in., from about 20 in. to about 50 in., or from about 20 in. to about 45 in.

6. The sauna of claim 1 wherein the bottom surface is defined by a bottom length and a bottom width and the bottom width is from about 20 in. to about 60 in., from about 25 in. to about 60 in., from about 25 in. to about 55 in., from about 25 in. to about 50 in., from about 30 in. to about 45 in., from about 30 in. to about 40 in., or from about 30 in. to about 35 in.

7. The sauna of claim 1, wherein the front surface and the bottom surface form an angle from about 70° to about 80°.

8. The sauna of claim 1, wherein the door comprises tempered glass, insulated tempered glass, thermopane glass, annealed glass, or plastic, of from about 0.2 in. to about 1.0 in. thickness.

9. The sauna of claim 8, wherein the door is treated or coated to retain at least 10% of incident electromagnet radiation with a wavelength of from about 0.7 μm to about 1 mm, 3 μm to about 1 mm, of from about 0.7 μm to about 10 μm, of from about 2 μm to about 10 μm, of from about 3 μm to about 10 μm, of from about 5 μm to about 10 μm, of from about 0.7 μm to about 5 μm, of from about 0.7 μm to about 3 μm, of from about 2 μm to about 3 μm.

10. The sauna of claim 1, wherein at least one of the bottom, top, front, optional top or bottom heel, or plurality of additional surfaces comprises wood, plastic, vinyl, steel, brass, or silicone.

11. The sauna of claim 1, wherein at least one of the bottom, top, front, optional top or bottom heel, or plurality of additional surfaces consist essentially of wood.

12. The sauna of claim 1, wherein the one or more heating components comprises one or more infrared heaters.

13. The sauna of claim 11, wherein the one or more infrared heaters is selected from the group consisting of a carbon infrared heater, carbon fiber infrared heater, infrared ceramic plates, or far infrared heater made of some combination of nickel, ferroalloy, Fecralloy®, quartz, tungsten, iron-chromium-aluminum alloy, or gold.

14. The sauna of claim 1, wherein the one or more heating components comprises an electric heating element, heated stones, fire, steam, metal wire, gas heater, or fan heater.

15. The sauna of claim 1, wherein at least one of the bottom, top, front, or plurality of additional surfaces comprises a window, vent, opening, door, door handle, or towel rack.

16. The sauna of claim 1, wherein the interior volume is no greater than about 80,000 in.³, no greater than about 75,000 in.³, no greater than about 70,000 in.³, no greater than about 65,000 in.³, no greater than about 60,000 in.³, no greater than about 55,000 in.³, no greater than about 50,000 in.³, no greater than about 45,000 in.³, or no greater than about 40,000 in.³.

17. The sauna of claim 1, wherein the interior volume is between about 40,000 in.³ and about 80,000 in.³, between about 40,000 in.³ and about 75,000 in.³, between about 40,000 in.³ and about 70,000 in.³, between about 45,000 in.³ and about 65,000 in.³, or between about 45,000 in.³ and about 50,000 in.³.

18. The sauna of claim 1, wherein the heating component is capable of heating the interior volume to a temperature between about room temperature and about 230° F., between about room temperature and about 180° F., between about room temperature and about 150° F., between about room temperature and about 130° F., between about room temperature and about 115° F., or between about room temperature and about 100° F.

19. The sauna of claim 1, wherein the sauna is powered by a 120 volt outlet or a 240 volt outlet.

20. A kit for assembling a sauna, comprising:
a bottom surface, an optional bottom heel surface, a top surface, an optional top heel surface, a front surface, a plurality of additional surfaces, one or more heating components; and a seat;
wherein at least one of the front surface and plurality of additional surfaces comprises a door;
wherein the top surface is configured to be parallel to the bottom surface when the sauna is assembled;
wherein the optional bottom heel surface is configured to be connected to the bottom surface and extend upwardly therefrom and the optional top heel surface is configured to be connected to the top surface and extend downwardly therefrom;
wherein the front surface is configured to be situated above the bottom surface and/or optional bottom heel surface and below the top surface and/or optional top heel surface, and wherein the front surface and bottom surface are configured to form an angle less than 90° when the sauna is assembled;
wherein the plurality of additional surfaces are configured to be connected to the bottom surface, optional bottom heel surface, top surface, optional top heel surface, and/or front surface such that the surfaces form an interior volume defined by the surfaces; and
wherein the seat is configured to be situated in the interior volume.
